(19) United States
(12) Patent Application Publication
(10) Pub. No.: US 2017/0177836 A1
(43) Pub. Date: Jun. 22, 2017

(54) FRACTIONAL ENTITLEMENTS

(71) Applicant: Cisco Technology, Inc., San Jose, CA (US)

(72) Inventors: Altan STALKER, Lawrenceville, GA (US); Stephen Tallamy, Sandhurst (GB); Edward Parker, Southsea (GB); Tony Leigh, Wokingham (GB)

(21) Appl. No.: 14/972,136

(22) Filed: Dec. 17, 2015

(51) Int. Cl. G06F 21/10; G06Q 50/18; H04W 4/00; G06Q 20/38

(52) U.S. Cl. CPC G06F 21/10; G06Q 20/3829; G06Q 50/184; H04W 4/008; G06F 2221/0746; G06Q 2220/12

(57) ABSTRACT

A device, system and related method are described, the method including receiving at an entitlement resource coordinator (ERC) a plurality of fractional entitlements over a network from a plurality of entitlement resource agents (ERAs), combining at a processor comprised in the ERC at least some of the plurality of fractional entitlements into a whole entitlement, using the combined whole entitlement to retrieve a key, and decrypting a content item according to the key. Related devices, systems and methods are also described.

### TECHNICAL FIELD

The present disclosure generally relates to entitlements for content utilization.

### BACKGROUND

Purchasing content and authorizing playback is typically done today with a single account in mind. That is to say, if Jane Doe has an account with a service provider, then the purchase of content is through Jane Doe's account, and only Jane Doe (or someone else authorized to use Jane Doe's account, for example, and without limiting the foregoing, Jane's spouse or child) is authorized to playback the purchased content. Through various mechanisms an account is used to purchase content (whether it be a single live event or an asset that can be replayed multiple times) and then, at playback, the same account is used to authorize a device to decrypt the content.

### BRIEF DESCRIPTION OF THE DRAWINGS

The present disclosure will be understood and appreciated more fully from the following detailed description, taken in conjunction with the drawings in which:

FIG. 1 is a simplified block diagram of a system for using fractional entitlements for use in purchasing and authorization playback of content, constructed and operative in accordance with an embodiment of the present invention;

FIG. 2 is a pictorial depiction of a first embodiment in which the system of FIG. 1 may be utilized;

FIG. 3 is a pictorial depiction of a second embodiment in which the system of FIG. 1 may be utilized;

FIG. 4 is a simplified block diagram illustration of an embodiment for implementing the system of FIG. 1;

FIG. 5 is a simplified block diagram illustration of different embodiments for using the fractional entitlements of FIG. 1; and

FIG. 6 is a simplified flowchart diagram of one method of operation of the system of FIG. 1.

### DESCRIPTION OF EXAMPLE EMBODIMENTS

### Overview

A device, system and related method are described, the method including receiving at an entitlement resource coordinator (ERC) a plurality of fractional entitlements over a network from a plurality of entitlement resource agents (ERAs), combining at a processor comprised in the ERC at least some of the plurality of fractional entitlements into a whole entitlement, using the combined whole entitlement to retrieve a key, and decrypting a content item according to the key. Related devices, systems and methods are also described.

### Exemplary Embodiments

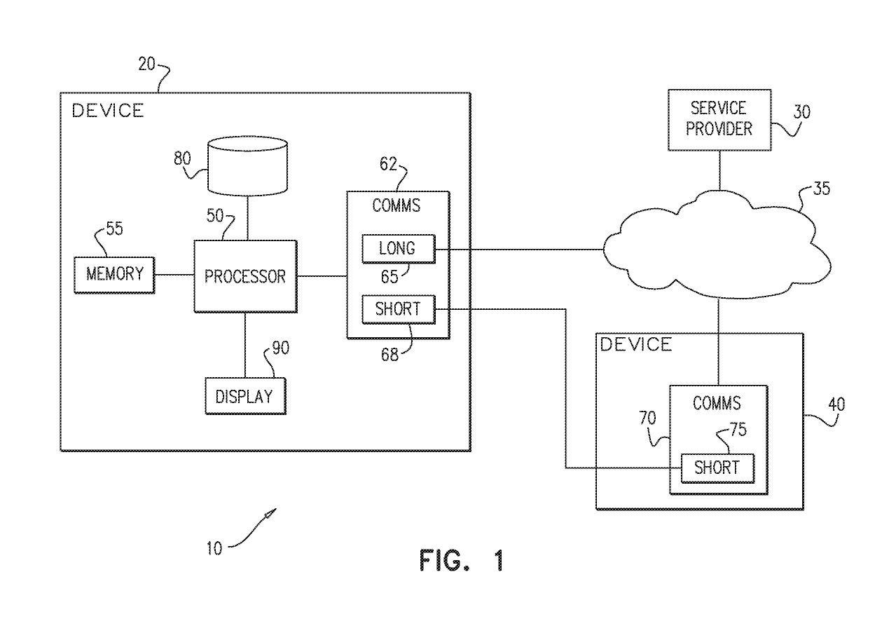

Traditional individual centric systems for purchasing content and authorizing playback typically may place financial burdens on a single individual (typically an account holder), and does not integrate well into today's increasing social networking. Reference is now made to FIG. 1, which is a simplified pictorial illustration of a system 10 for using fractional entitlements for use in purchasing and authorizing playback of content, the system 10 constructed and operative in accordance with an embodiment of the present invention. A first device 20 is in communication with a service provider 30 over a network 35. The first device 20 is also in communication with a second device 40. The second device 40 is also in communication with the service provider 30 over the network 35. The network 35 may be the Internet, a cable or satellite TV network, a combination of these three types of networks, or any other appropriate communications network.

It is appreciated throughout the description of FIG. 1 specifically and in the other figures that some details may be omitted from the figures for ease of depiction and description.

Each of the first device 20 and the second device 40 has received at least one fractional entitlement from the service provider 30. Prior to providing a detailed description of the operation of the system 10 of FIG. 1, some embodiments of the system 10 will be provided.

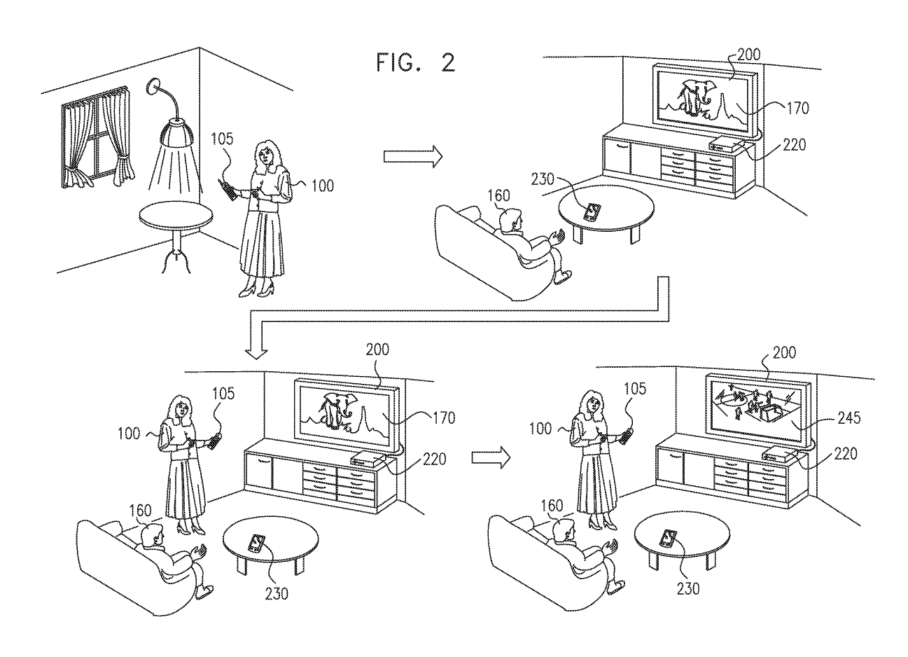

Reference is now made to FIG. 2, which is a depiction of a first embodiment in which the system 10 of FIG. 1 may be utilized. In the first pane of FIG. 2, a first user, Jane 100, purchases (and potentially pays a premium) for a portable entitlement to a particular service—for example a premium sports channel. The portable entitlement may be stored on a device 105 which Jane 100 is carrying. It is appreciated that the device 105 corresponds to the first device 20 of FIG. 1. As will be explained below, portable entitlements are a type of fractional entitlements.

In the second pane of FIG. 2, Pete 160 is watching a nature show 170 on his television 200. In the present example, the television 200 is connected to a set top box or digital video recorder (DVR) 220. If an entitlement is required to view the nature show 170, it may be stored on the DVR 220. Alternatively, Pete's device 230, which may be a tablet or other hand held computing device corresponding to the second device 40 (FIG. 1), may store the entitlement required to view the nature show 170. In such a case, Pete's device 230 communicates the required entitlement to view the nature show 170 to one of the DVR 220 or the television 200, so that the nature show 170 may be viewed.

Turning now to the third pane of FIG. 2, Jane 100 goes to visit Pete 160. Pete 160 has not purchased any sort of entitlement to view the premium sports channel for which Jane 100 has purchased the portable entitlement. Pete 160 and Jane 100 decide to view the premium sports channel. Jane's device 105 which stores the portable entitlement which Jane 100 had purchased earlier, communicates to Pete's DVR 220 (or Pete's device 230) that the required portable entitlement is now available. Pete's DVR 220 (or Pete's device 230) does, however, have an entitlement to “borrow” the portable entitlement view the premium sports channel from Jane's device 105. The use of the term “borrow”, above, is understood to mean that the Jane's 100 entitlement may be legitimately used by a device not owned or controlled by Jane 100, such as, in this example, Pete's device 230.

Alternatively, Pete's DVR 220 may not have such an entitlement. Rather, the “environment” (i.e. at least an arrangement with the service provider 30 of FIG. 1 allowing “borrowing” of entitlements, in a local network conducive to such borrowing) in which these portable entitlements are used may simply allow such borrowing.

In the fourth pane of FIG. 2, DVR 220 (or Pete's device 230) uses the borrowed portable entitlement from Jane's device 105, and displays content from the premium sports channel 245 on the television 200.

It is appreciated that Jane 100 and Pete 160 may opt to view the premium sports channel 245 on any appropriate device, such as Pete's device 230, and in FIG. 2 the television 200 is mentioned by way of a non-limiting example. It is also appreciated that the portable entitlement may not be available at Jane's 100 permanent residence (i.e. pane 1, above; this may be a function, for instance, of an arrangement between the service provider 30 (FIG. 1) and Jane 100). Additionally, the service provider 30 (FIG. 1) may sell the portable entitlement to Jane 100 on a daily basis, or a two to three day basis, a weekly basis, a permanent basis, and so forth.

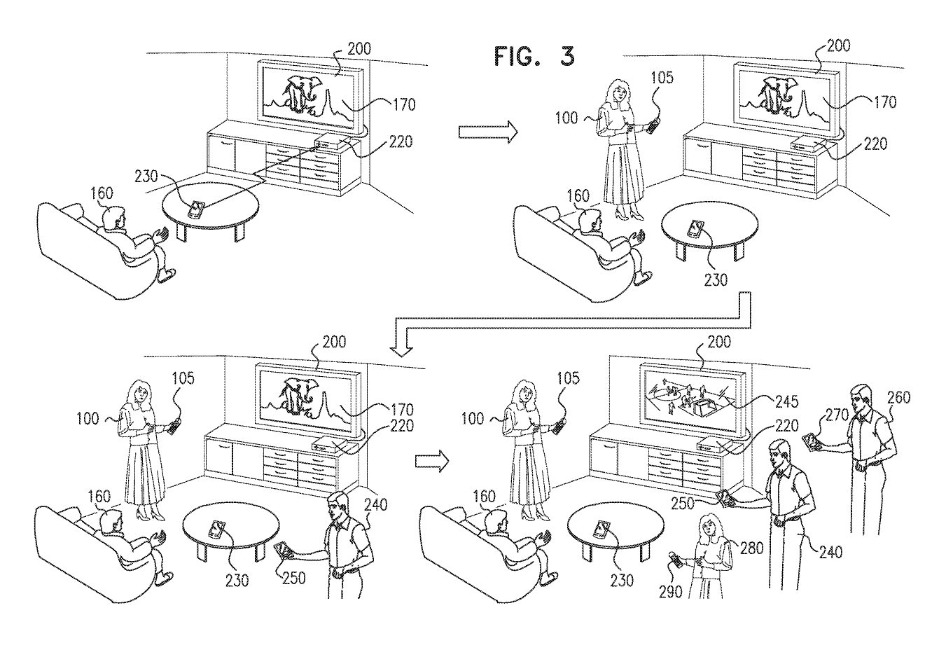

Reference is now made to FIG. 3, which is a depiction of a second embodiment in which the system of FIG. 1 may be utilized. In the first pane of FIG. 3, as in the second pane of FIG. 2, Pete 160 is watching the nature show 170 on his television 200. Jane 100 then enters the room (depicted in the second pane of FIG. 3), as does Alan 240 (depicted in the second pane of FIG. 3). Previously, the service provider 30 (FIG. 1) has advertised that a major sporting event is being made available for combined purchasers of fractional entitlements. All three of Pete 160, Jane 100, and Alan 240 have a fractional entitlement (in this case, each has ⅕^{th} of a whole entitlement) to watch a major sporting event (i.e. the “big game”) on their respective devices 230, 105, 250. However, in the present example five fractional entitlements are required in order to view the major sporting event 245 (not depicted in panes 1-3). Only when Edward 260 and Francis 280 enter the room (as is shown in pane 4), because each one of Edward 260 and Francis 280 also have a fractional entitlement on their respective devices 270, 290, are all of the five friends able to view the major sporting event 245.

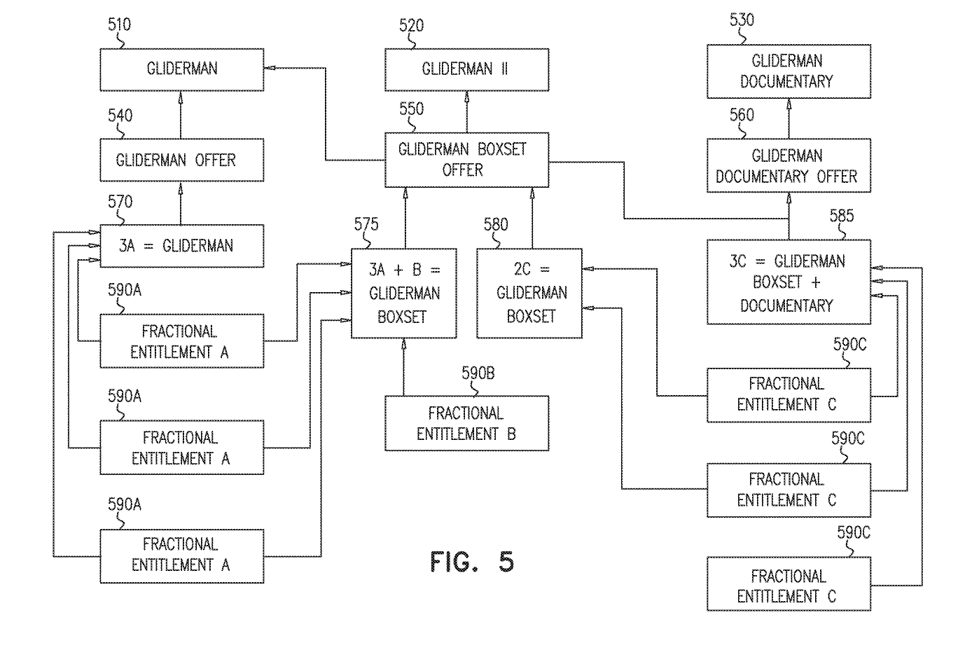

It is appreciated that the choice of requiring five fractional entitlements (i.e., each device effectively bears ⅕^{th} of a whole entitlement) is just one possible configuration of the system 10 (FIG. 1) which may be provided by the service provider. As will be discussed below, with reference to FIG. 5, the service provider may offer one or more combinations of fractional entitlements which could be used to purchase the event and possibly additional services, such as the ability to “lend” and “borrow” entitlements, as described above, with reference to FIG. 2. The users (i.e. Pete 160, Jane 100, Alan 240, Edward 260, and Francis 280) may select one or more options of fractional entitlements, and combine them “on the go”. For example, if five ⅕^{th} entitlements are needed to view a particular event, and among all of the users only four participants have the needed fractional entitlements, then one or more participant may purchase the required additional fractional entitlement.

It is also appreciated that a single fractional entitlement, in typical usage, is not usable alone. Typically, a combination of at least two fractional entitlements is needed to obtain viewing rights to a given content item. Various options for combining fractional entitlements is described below with reference to FIG. 5.

It could be that Pete 160, Jane 100, Alan 240, Edward 260, and Francis 280 have used some sort of social media in advance to arrange the joint purchase of the required fractional entitlements. For instance, one of the five friends may have invited the other four to join in a joint purchase of the fractional entitlements. The social media platform may also be provided by the service provider 30 (FIG. 1).

It is appreciated that the purchasing and pricing model for the fractional entitlements is subject to a decision of the service provider 30 (FIG. 1). There might be a premium charged for purchase of the fractional entitlements. By way of a non-limiting example, if an entitlement for a single subscriber to view the major sporting event of FIG. 3 would cost that single subscriber $25, and five fractional entitlements are required to view the major sporting event, then each fractional entitlement might cost $6, thereby enabling the service provider 30 (FIG. 1) to charge a total of $30 instead of $25. It is appreciated, however, that the business arrangement between the service provider 30 (FIG. 1) and its various subscribers (such as Pete 160, Jane 100, Alan 240, Edward 260, and Francis 280, etc.) is beyond the scope of the present description. Furthermore, the cost of each the fractional entitlements is a matter of configuration details of the system of FIG. 1.

In a further enhancement of the embodiment depicted in FIG. 3, should a sixth friend who also purchased a fractional entitlement to view the major sporting event 245 now enter the room, then the group of friends may now be entitled to some enhanced viewing of the content, such as multi-angle viewing of the content; high definition viewing of the content; 3-D viewing of the content, and so forth (as will be discussed below with reference to FIG. 5).

Returning now to the description of FIG. 1, it is appreciated that Jane's device 105 (FIGS. 2 and 3) substantially corresponds with the first device 20. Similarly, Pete's 230, Alan's 240, Edward's 260, and Francis's 280 respective devices 105, 250, 270, 290, each substantially correspond with an instance of the second device 40. Furthermore, it is appreciated that many of the components which are described below as being in the first device 20 may also be, correspondingly disposed in the second device. The first device 20 and the second device 40 typically comprise standard components which are well known to persons skilled in the art. Such components may not necessarily be described in the present specification and/or depicted in the figures in the interest of brevity and clarity.

The first device 20 comprises a processor 50 such as an embedded microprocessor. Furthermore, the first device 20 may comprise more than one processor 50. One of the processors 50 may be a special purpose processor operative to perform the management of fractional entitlements according to the methods described herein. The processor reads instructions from and writes to a memory, such as memory 55, such that the instructions enable performing the method(s) of the present invention.

The processor 50 operates communication interfaces 62 to receive and exchange fractional entitlements, as well as other information. A long-range communication interface 65, such as a cellular or satellite network interface, communicates with the network 35. Alternatively or additionally, the network 35 may comprise a terrestrial network, such as the public Internet, and the communication interfaces 62 may communicate with the network 35 through a wireless local area network (WLAN) access point (not depicted).

The communication interfaces 62 comprise a short-range communication interface 68, such as a Bluetooth interface or an NFC interface, to communicate with other devices, such as second device 40. The short-range communication interface 68 is typically operated by the processor 50. The short-range communication interface 68 may also, or alternatively, be operative over a local area network, such as a home's WiFi network. In some embodiments, communication between the first device 20 and the second device 40 may not be via short range communication. For example, the first device 20 and the second device 40 may communicate with each other via long range network through the service provider (e.g. using XMPP, web sockets or other standard ways of devices communicating via a central service). It is appreciated, however, that techniques known in the art for ensuring proximity of devices, such as the first device 20 and the second device 40, may, however, be implemented in the system 10 (FIG. 1). In general, an appropriate method for device proximity detection may be selected by the service provider 30 depending on a desired level of strictness, as required by the service provider 30 and its related content providers.

Proximity detection would likely use any combination of: local network detection; communication with latency below a configured threshold; communication utilizing no more than a configured maximum number of hops; GPS location; hardened software on devices 20, 40; and any other techniques known in the art.

The second device 40 also comprises communication interfaces 70, including short short-range communication interface 75, through which the second device 40 communicates with the first device 20.

As noted above, the processor 50 operates communication interfaces 62 to receive fractional entitlements. The processor then is able to combine at least some of the received fractional entitlements into a whole entitlement. Various ways of combining the at least some of the received fractional entitlements into a whole entitlement are discussed in detail below. Once the processor 50 has the combined whole entitlement, the processor retrieves a key on the basis of the combined whole entitlement, using techniques known in DRM (digital rights management) and/or CA (conditional access), or other appropriate methods known to persons of skill in the art. The retrieved key can then be used to decrypt a content item. Once decrypted, the content item may then be viewed.

The first device 20 and the second device 40 may comprise a fractional entitlement store 80 for storing fractional entitlements when they are received from the service provider 30 via the long-range communication interface 65. In an alternative embodiment, the fractional entitlements may not be stored directly on the device itself but rather stored in the cloud. The fractional entitlement store 80 may also store fractional entitlements received from other devices, such as, but not limited to the second device 40.

DRM/CA may be implemented either locally or in the cloud, depending on where the fractional entitlements are stored. Non-spoofable authentication and proximity/location of the device that is associated with the fractional entitlements may typically be provided by the DRM/CA systems in order to provide for a minimal security level. For example, before a fractional entitlement may be used, a check might be performed to ensure that the device, such as device 20, with which the fractional entitlement to be used is associated, is in proximity of one of: the second device 40; the DVR, such as DVR 220; and a remote display (as opposed to a local display, such as display 90).

Additional security might be provided by having the fractional entitlements digitally signed, for example, with a private key, prior to distribution, and verified, prior to usage, with a public key. The public key could be system-wide or could relate to specific offers (so that a fractional entitlement could not be used for anything other than the offer to which it relates).

The processor 50 also drives a user interface, including, but not limited to the display 90. Display 90 is configured to display content; display messages from the system 10, such as requests/offers to purchase and/or to share fractional entitlements; and so forth.

The fractional entitlements themselves may carry information regarding their use in an appropriate field. For instance, one field may note that a total of N fractional entitlements (where N is a whole number) may be required in order to view content. Should only N−1 fractional entitlements be available, then, in the absence of one additional fractional entitlement, the desired content itself may be unavailable.

It is appreciated that in the case where, say, 5 fractional entitlements are required to view the desired content, but only 4 fractional entitlements are available among the various devices in communication with each other, then the service provider 30 may offer to “up sell” another fractional entitlement to the users wishing to view the desired content, thereby enabling viewing of the desired content. The display 90, in such a case, by way of example, may display a message indicating that “just one more person with a fractional entitlement is needed.” An offer to sell the entitlement may accompany the message. By contrast, when an “extra” fractional entitlement is available, e.g. six devices are fractional entitlements are in proximity of each other, while only 5 fractional entitlements are needed to view the content, then the service provider 30 may offer to enable extra services, such as 3D viewing, HD or UltraHD content instead of lower resolution content, or multi-angle views of the content, and so forth. Situations such as this are described below with reference to FIG. 5.

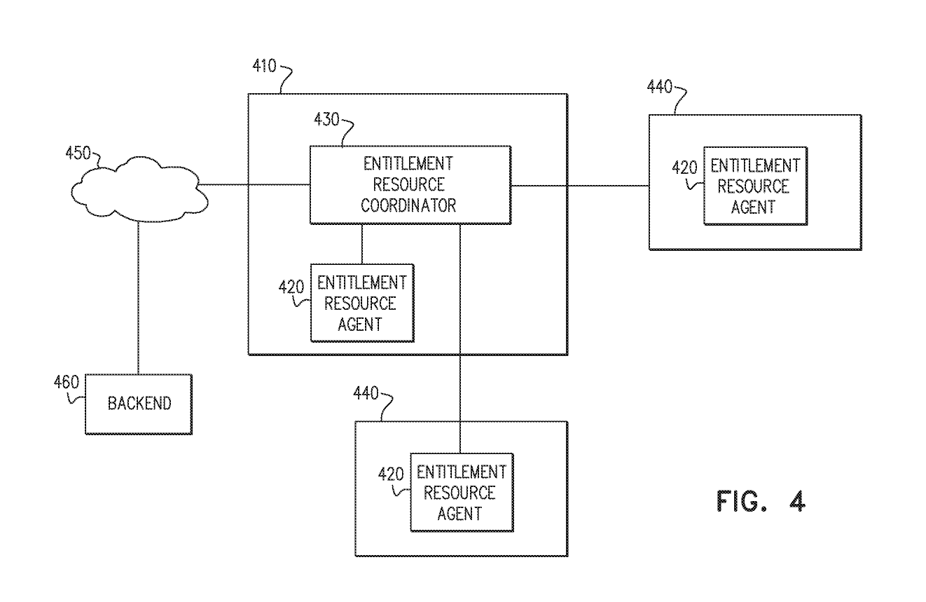

In some cases there might be a requirement of the service provider 30 that a minimum number of devices, such as devices 105, 230, 250, 270, and 290 need to remain in short-range communication distance of each other in order to enable the viewing of the content item obtained by combining the fractional entitlements, e.g., the major sporting event 245. Alternatively, should the minimum number of devices be lacking, viewing may continue for a pre-defined amount of time, enabling a person holding a device having one of the fractional entitlements to briefly leave the short-range communication distance of the other devices. For example, if Alan 240 takes his mobile phone (i.e. device 250) out of communication range, for example, of the other devices 105, 250, 270, 290, or the DVR 220 say, to make a private phone call. More details as to specific devices and how the various devices relate to each other are provided below with reference to FIG. 4.

Reference is now made to FIG. 4, which is a simplified block diagram depiction of an embodiment for implementing the system of FIG. 1. A device 410, 440 corresponding to at least one of the first device 20 (FIG. 1) and the second device 40 (FIG. 1), comprises an entitlement resource agent (ERA) 420. The ERA 420 stores and communicates the fractional entitlements of the device owner (such as Jane 100, Pete 160, Alan 240, Edward 260, and Francis 280 (FIGS. 2 and 3)). The ERA 420 may be an application on the device 410 or may comprise specialized hardware embedded in the device 410. The ERA 420 may also be part of some physical token disposed in the device 410, such as an NFC card. The ERA 420 will be hardened (i.e. made more secure than surrounding systems and devices, using techniques known in the art) and use industry standard (or proprietary) mechanisms to avoid tampering and ensure it is communicating with an authentic endpoint. As was noted above, DRM and CA may be used to provide desired security functions. In embodiments where fractional entitlements may be stored in the cloud, then the ERA 420 typically would provide device token identity information that would be used to retrieve the fractional entitlements associated with the device 410.

At least one device 410, corresponding to the first device 20 (FIG. 1), comprises an entitlement resource coordinator (ERC) 430. ERCs 430 are implemented on various devices 410 (such as devices 105, 230, 270, and 290 and DVR 220 (FIG. 3)) and may be implemented on devices capable of displaying content (e.g., utilizing the display 90 of first device 20 of FIG. 1). In an alternative embodiment, the ERC 430 may be implemented on a device which does not also comprise an ERA 420. The ERC 430 creates a network, or uses existing networks, or other technology such as NFC, to announce its existence and receive information from ERAs 420 on other devices 440. The ERC 430 is in communication, typically over a network 450 (such as network 35 of FIG. 1) with a backend 460, such as a backend 460 implemented by service provider 30 of FIG. 1. The ERC 430 communicates information received from ERAs 420 to the backend 460.

The ERC 430 may store fractional entitlements which it receives, in either short term memory (e.g. RAM) or long term storage (e.g. a hard drive or a flash drive). In such a case, if one of the devices having one of the fractional entitlements be removed from communication range of the ERC 430, the ERC 430 might be able to use the stored fractional entitlement either until the device which was removed is returned to communication range of the ERC 430, or for some pre-defined period of time. Alternatively, the ERC 430 may not store the fractional entitlements, but rather, as long as the other devices 440 are in communication with the ERC 430, the ERC 430 may continue to utilize the fractional entitlements stored by the ERAs 420 in the other devices 440. There may be various time ranges, as discussed above, which allow one or more of the other devices 440 to temporarily loose communication with the ERC 430 without loss of the use of those fractional entitlements (as was discussed above).

The backend 460 determines whether access criteria for viewing desired content have been meet. For example, if five fractional entitlements are needed to enable viewing, and only four are available, then the access criteria for viewing have not been met. Alternatively, the ERC 430 may be able to make a local decision regarding access, if the ERC 430 is supported by a secure system (such as the hardening mentioned above). The ERC 430 is typically comprised on the device 410 that receives content and performs decryption and decompression of encrypted compressed received content, before outputting the content to a display, such as display 90 of FIG. 1.

The ERA 420 and the ERC 430 are typically located on the same network, but multiple networks may exist. For example, the ERC 430 may announce its availability via a Wi-Fi network as well as a Bluetooth network. The ERAs 420 which are in an appropriate communication range may then join one of these networks, then through discovery learn that at least one ERC 430 exists on one of these networks. Then the ERAs 420 may communicate in a secure manner with the ERC 430. Alternatively, an NFC or other technology can be used to enable communications between the ERAs 420 and the ERC 430. In another alternative embodiment, the ERC 430 may discover ERAs 420 not located on one of these networks via the Service Provider 30 (FIG. 1). For example the ERC 430 application may ask the user which other user(s) they would like to bring into the ERC 430 network to participate in a content purchase. The ERC 430 will utilize the service provider backend 460 to bring other users' ERAs 420 to communicate with the ERC 430, possibly over long range networks, such as network 450. As was mentioned above, XMPP, or other appropriate communication protocol may be used for such communications. There are many ways this communication can be secured including TLS, certificates, and so forth, as is known in the art. The ERA 420 application may query the user (e.g., via a message displayed on display 90 of FIG. 1) whether the user wishes to participate with a particular ERC 430, providing the owner of the device 410 comprising the ERC 430 control of the user's fractional entitlement.

It is also appreciated that the device 410 which comprises the ERC 430 will also typically comprise an ERA 420, as is shown in FIG. 4. However, the ERC 430 may, in some embodiments, be implemented in a device that does not comprise an ERA 420. Accordingly, the device comprising the ERC 430 need not, itself, have any fractional entitlements.

In another embodiment, while the ERA 420 and ERC 430 are on the same network, separate ERCs 430 may interact to allow viewing content at different locations. For example, Jane 100, Pete 160, Alan 240 and Francis 280 each have obtained fractional entitlements to watch the sporting event, as described above, but Francis 280 is in another city and watches remotely. The service provider 30 (FIG. 1) may choose to offer this viewing flexibility with a special price point. Since the ERC 430 to which Jane 100, Pete 160, Alan 240 and the ERC 430 to which Francis 280 are already connected to the backend 460, the backend 460 can evaluate which fractional entitlements are available to such a “network of ERCs 430”. This capability enables the backend 460 to enable remote viewing, and communicate that ability to the two ERCs 430. Such a situation is analogous to having an ERC 430 in the cloud.

Once the network is established as described above as a basis for communication between the ERC 430 and the ERA 420, then at a higher level in a protocol stack, the discovery and communication of the ERA 420 and the ERC 430 may be implemented over a proprietary protocol. However those of skill in the art will appreciate the discovery and communication of the ERA 420 and the ERC 430 may alternatively occur using an extension of existing protocols such as DLNA (Digital Living Network Alliance). To achieve this, an additional DNLA profile would be specified to allow ERAs 420 to declare the availability of fractional entitlements to the ERC 430 in a similar way that audio devices can currently declare a capability to output audio via DNLA.

As mentioned above, the ERC 430 may determine that not enough fractional entitlements are present to allow viewing. Based on a policy configured by the service provider 30 (FIG. 1), the ERC 430 may send a message to the various ERAs 420 (using a technology appropriate to communications over the network by which the ERAs 420 and the ERC 430 communicate) indicating this fact as well as displaying an alert on the location's main display (such as the television 200 or devices 105, 230, 250, 270, 290 of FIGS. 2 and 3). The message sent to the ERAs 420 would include a unique identifier and metadata needed to describe a suggested purchase. At this point any device 410, 440 on the network not currently offering a fractional entitlement for the content will receive and possibly display a message offering an option to “join in for just XX dollars” (or similar) and purchase a fractional entitlement to allow the upcoming (or active) event to be viewed. Upon purchase completion, the display may show a message along the lines of: “George has joined into allow viewing”.

All purchasing is done though methods known in the art and use hardened security as is known in the art. In the case of a purchase from a mobile device, the device will communicate over the network to the service provider 30 (FIG. 1) purchasing system using appropriate networking technology (including, but not limited to IP, TCP, HTTP, HTTPS, etc.). If the transaction is successful, the ERA 420 will receive a fractional entitlement (in a secure manner, using techniques known in the art), which will then be communicated to the ERC 430. The ERC 430 or the backend 460 will reevaluate whether an appropriate number of fractional entitlements are present in order to allow the content to be displayed.

Generically, and as was mentioned briefly above, using the ERA 420 or a web service offer by the service provider 30 (FIG. 1), a user can create a viewing group for an event. The user will be able to select an event, either current or in the future, and assign a name such as “Jane's Big Event”. The user is then able to select other people to whom to send an invitation to purchase a fractional entitlement to the user created event. The user created event typically is used as a way to simplify communication of the event (as if Jane were to send a message to her friends: “hey, let's all chip in and watch this”). However, this embodiment may not restrict partial entitlements to this group. For example, if someone who was not in the user created viewing group showed up unannounced, but had purchased a fractional entitlement for the event, that fractional entitlement for the event may work as well as anyone else's. However, an option might exist to create a private group for a user created viewing group, in which case, membership in the group (i.e. the option to join with other holders of the user created viewing group to view the content) might be restricted to only members of the viewing group.

Additionally, the user (e.g. Jane 100 (FIGS. 2 and 3)) may be given a unique code which the user can use in the absence of an invitation (which they can distribute to other friends using whatever mechanism they choose). The backend 460 maintains these event names/codes and allows other users to access them when running the ERA 420 or accessing a web service. In either case, upon purchasing a fractional entitlement, once the unique code is provided, the entitlement is securely delivered to the purchaser's ERA 420.

In another embodiment, physical tokens (such as NFC cards) which hold fractional entitlements may also be made available for some events. For instance, subscribers of the service provider 30 (FIG. 1) at a high subscription level might receive a physical token comprising a fractional entitlement for free or at a discounted price, while regular subscribers of the service provider 30 (FIG. 1) might have to pay a premium price to receive the physical token. In another example of the present embodiment, a sponsor or promoter could distribute such physical tokens comprising fractional entitlements that would need to be combined with other user's fractional entitlements—effectively allowing the sponsor to fund a discount to the end users' content purchase.

Referring briefly back to FIG. 2, Jane 100 and her friends (e.g., Pete 160, etc.) might go into a store and purchase fixed purpose tokens that hold fractional entitlements and are detected by the ERC 430 using a network technology supported by the physical tokens (such as NFC). Purchasing of fractional entitlements via different routes may not require a direct relationship to the service provider—i.e., purchase could be in a physical store, via a text message, via alternative payment mechanisms, and so forth. However, activation of such token-bound fractional entitlements would be via a relationship of the viewing devices with the service provider. For instance, only subscribers of the service provider may be able to use the token-bound fractional entitlements to view the desired content. That is to say that the service provider would have to issue and accept all fractional entitlements—so there must be some relationship between the service provider and the entity offering the fractional entitlements. However the user purchasing the fractional entitlement may have no regular on-going relationship to the service provider.

In another embodiment, a fractional entitlement may be explicitly linked to a particular offer (such as buying a ticket to a movie, where the user has selected a particular movie to see) or linked to a set of different offers (such as buying a cinema voucher to use for any movie). For example, upon purchase of a movie ticket, where the user's device 410 is used to execute the purchase of the movie ticket, and, upon completion of the transaction, or when the ticket is used, etc., a fractional entitlement may be delivered to the user's device 410.

Returning to the discussion of FIG. 4, in an alternative embodiment, when the fractional entitlement is held in the cloud but is associated to a particular ERA 420, the ERA 420 does not store actual fractional entitlements. Rather, the fractional entitlements are associated with the user account in the backend 460. The ERA 420 in the mobile device (such as device 410, 440) is used to identify the user account to the ERC 430. The ERC 430, with the help of the back end 460 looks up what fractional entitlements are associated with the ERA 420. Further, the ERA 420 need not be present beyond the initial authorization depending on the service provider's system configuration.

Reference is now made to FIG. 5, which a simplified block diagram illustration of different embodiments for using the fractional entitlements of FIG. 1. Three different content items are available for viewing in the exemplary embodiments depicted in FIG. 5: Gliderman 510; Gliderman II 520 (the sequel to Gliderman 510); and the Gliderman Documentary 530.

Three different offers are available enabling consumers to purchase the three different content items: a Gliderman offer 540; a Gliderman boxset offer 550; and a Gliderman documentary offer 560. The Gliderman offer 540 enables purchasing the Gliderman 510 content item. The Gliderman boxset offer 550 enables purchasing both the Gliderman 510 content item and the Gliderman II 520 content item. The Gliderman documentary offer 560 enables purchasing Gliderman documentary 530 content item.

In order to purchase the Gliderman offer 540, to obtain viewing (and possibly recording) rights to the Gliderman 510 content item, three fractional entitlements of a first type 570, referred to here as type A are required. When three devices (such as devices 410 and 440 of FIG. 4) are within communication range of a common ERC 430 (FIG. 4, as explained above—allowing for the various special cases also mentioned above), and each of those devices have a fractional entitlements of type A 590A, then, using the methods described with reference to FIG. 4, those three devices can jointly purchase the Gliderman offer 540, and obtain all of the rights in the Gliderman content item 510 which are included in the offer. Alternatively one device may have multiple fractional entitlements associated with it, for example, two fractional entitlements of type A 590A. The one device may be within communication with one other device with one fractional entitlement of type A 590A to form a set of three fractional entitlements of type A 590A to purchase the Gliderman offer 540.

The Gliderman boxset offer 550 may be purchased in one of two ways. In the first way, three fractional entitlements of type A 590A and one fractional entitlement of a second type, referred to here as type B 590B are required 575. When three devices (such as devices 410 and 440 of FIG. 4) are within communication range of a common ERC 430 (FIG. 4, as explained above—allowing for the various special cases also mentioned above), and each of those devices have a fractional entitlements of type A 590A, and an additional device (such as devices 410 and 440 of FIG. 4) having a fractional entitlement of type B 590B is also within the same communication range, then, using the methods described with reference to FIG. 4, those four devices can jointly purchase the Gliderman boxset offer 550, and obtain all of the rights in the Gliderman content item 510 and the Gliderman II content item 520 which are included in the offer.

Alternatively, two fractional entitlements of a second type 580, referred to here as type C 590C which are found on devices within communication range of a common ERC 430 (FIG. 4, as explained above—allowing for the various special cases also mentioned above), may be used to purchase the Gliderman boxset offer 550, and obtain all of the rights in the Gliderman content item 510 and the Gliderman II content item 520 which are included in the offer.

In another embodiment, (omitting, for the sake of brevity, some of the details mentioned above), three fractional entitlements of type C 590C may be joined together 585 in order to purchase both the Gliderman boxset offer 550 and the Gliderman documentary offer 560.

It is appreciated that the above examples are described here to illustrate various ways in which the system 10 of FIG. 1 may be utilized, and not to limit or exclude other cases which are not mentioned or discussed. For example, there might be an offer to purchase only the Gliderman II content item 520 or the only Gliderman documentary content item 530.

Another possible embodiment might include the embodiment mentioned in FIG. 2, where one device (such as Jane's device 105 (FIG. 2)) has a fractional entitlement to view a particular content item (such as Gliderman 510) and to lend the content item to others, and a second device (such as Pete's device 230 (FIG. 2)) has a fractional entitlement enabling borrowing content (or entitlements to view content) from other clients.

Still another possible embodiment might include an embodiment where one device (such as Jane's device 105 (FIG. 2)) has a fractional entitlement to view a particular content item (such as Gliderman 510) and a second device (such as Pete's device 230 (FIG. 2)) has a fractional entitlement to view content in ultra-high definition (UltraHD). As long as Jane's device 105 and Pete's device 230 (both in FIG. 2) are in communication range of a common ERC 430 (FIG. 4, as explained above—allowing for the various special cases also mentioned above), or otherwise satisfy any proximity requirements of the service provider, then they are able to view Gliderman 510 in UltraHD.

Furthermore, although the present example described these fractional entitlements as combining linearly/additively, those skilled in the art will appreciate that the entitlements might combine in other manners as well. For example, and without limiting the generality of the foregoing, non-linear approaches could be used. For example, Jane might have 5 fractional entitlements and Jack might have two fractional entitlements, but the number of fractional entitlements may be multiplied together (rather than added) to see if they exceed some value. By way of example, Jane's 5 fractional entitlements might be multiplied by Jack's 2 fractional entitlements, to give a value of 10. If 8 is the value which must be exceeded, than Jane and Jack may view the content item.

In still other embodiments, the fractional entitlements may be combined in other ways as well. For example, and without limiting the generality of the foregoing, each of the fractional entitlements may comprise a part of a secret and when a sufficient number of parts of the secret are available to be combined together, the secret may be determined. The secret may, for example, comprise a key required to decrypt the content item, or may itself be required to decrypt an encrypted version of a key needed to decrypt the content item. A method for sharing a secret in this fashion is described in, “How to Share a Secret”, Adi Shamir, Communications of the ACM, November 1979, Vol. 22, no. 11.

In another embodiment, the fractional entitlements may be combined, e.g., concatenated, XOR-ed, etc. together in order to yield a value that is then used as a key. This key may then be used to decrypt the content item, or may itself be required to decrypt an encrypted version of a key needed to decrypt the content item.

In still another embodiment, a table of unique identifiers of the fractional entitlements may be maintained at the backend 460 (FIG. 4). The ERC 430 (FIG. 4) then sends the backend the unique identifiers of the fractional entitlements to be combined. The backend 460 (FIG. 4) then notes in an appropriate table that the combined fractional entitlements have been used (and may not be used again). Once the required number of fractional entitlements have been marked as used by the backend 460 (FIG. 4), the backend then sends a key to decrypt the content item, to the ERC 430 (FIG. 4).

It is appreciated that that the present invention may be implemented on top of existing conventional content purchasing systems such as are known in the art, including, but not limited to conditional access systems, DRM systems, digital rights lockers etc.

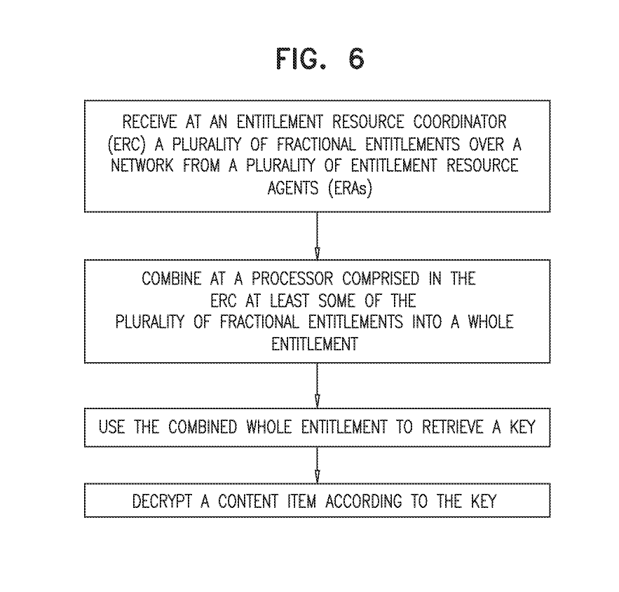

Reference is now made to FIG. 6, which is a simplified flow chart of one embodiment described herein. The method of FIG. 6 is believed to be self-explanatory with reference to the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method comprising:
receiving at an entitlement resource coordinator (ERC) a plurality of fractional entitlements over a network from a plurality of entitlement resource agents (ERAs);
combining at a processor comprised in the ERC at least some of the plurality of fractional entitlements into a whole entitlement;
using the whole entitlement to retrieve a key; and
decrypting a content item according to the key.

2. The method according to claim 1 and further comprising sending the whole entitlement to the service provider along with a request to view the content item.

3. The method according to claim 1 wherein the receiving the plurality of fractional entitlements occurs at a short range communication interface disposed in the ERC which is in communication with a second short range communication interface disposed in at least one of the plurality of ERAs.

4. The method according to claim 1 and further comprising the ERC receiving the content item.

5. The method according to claim 4 and further comprising displaying the content item after the decrypting.

6. The method according to claim 5 wherein the displaying content is performed on the ERC.

7. The method according to claim 1 and further comprising storing the plurality of received fractional entitlements in a fractional entitlement store implemented on the ERC.

8. The method according to claim 7 wherein the fractional entitlement store is implemented in short term memory.

9. The method according to claim 5 wherein the displaying occurs as long as the first communication interface is able to communicate with at least one device comprising one of the plurality of ERAs.

10. The method according to claim 5 wherein the displaying continues for a pre-defined amount of time after at least one device comprising one of the plurality of ERAs ceases communicating with the ERC.

11. The method of claim 1 wherein the combining at least some of the plurality of fractional entitlements into a whole entitlement comprises additively combining at least some of the plurality of fractional entitlements.

12. The method of claim 1 wherein the combining at least some of the plurality of fractional entitlements into a whole entitlement comprises non-linearly combining at least some of the plurality of fractional entitlements.

13. The method according to claim 1 wherein at least some of the plurality of fractional entitlements are received at the ERC from at least one of the plurality of ERAs over a long range network.

14. The method according to claim 1 wherein at least some of the plurality of fractional entitlements which are combined into a whole entitlement are one of:
associated with the content item; or
not associated with a particular content item.

15. The method according to claim 1 wherein the whole entitlement is associated with an entitlement to services provided in addition to the content item.

16. The method according to claim 1 and further comprising, prior to the combining, the processor performing a non-spoofable authentication of at least one device that is associated with at least one of the fractional entitlements which is to be combined.

17. The method according to claim 1 wherein the combining at least some of the plurality of fractional entitlement into a whole entitlement comprises performing proximity detection on at least one of: one of the plurality of ERAs; a DVR; or a remote display.

18. The method according to claim 1 and further comprising executing a DLNA (Digital Living Network Alliance) protocol in order to establish communication with at least one of the plurality of ERAs.

19. A device comprising:
an entitlement resource coordinator (ERC) first communication interface, the ERC first communication interface being operable to couple to a network so as to receive a plurality of fractional entitlements over the network from a plurality of entitlement resource agents (ERAs); and
a processor which combines at least some of the plurality of fractional entitlements into a whole entitlement; and
a key based on the whole entitlement, according to which the processor utilizes to decrypt a content item.

20. A device comprising:
means for receiving at an entitlement resource coordinator (ERC) a plurality of fractional entitlements over a network from a plurality of entitlement resource agents (ERAs);
means for combining at least some of the plurality of fractional entitlements into a whole entitlement;
means for using the combined whole entitlement to retrieve a key; and
means for decrypting a content item according to the key.
